(19) United States
(12) Patent Application Publication
(10) Pub. No.: US 2017/0367415 A1
(43) Pub. Date: Dec. 28, 2017

(54) GARMENT INCLUDING A PLURALITY OF SENSORS AND A CHIP

(71) Applicant: Christian Tubbs, Nesconset, NY (US)

(72) Inventor: Christian Tubbs, Nesconset, NY (US)

(21) Appl. No.: 15/190,962

(22) Filed: Jun. 23, 2016

(51) Int. Cl. A41D 1/00; G06F 3/14; A41B 1/08; A41D 1/08

(52) U.S. Cl. CPC A41D 1/002; A41D 1/08; G06F 3/1446; A41B 1/08; G09G 2354/00; G09G 2370/16; G09G 2320/08

(57) ABSTRACT

A garment is provided. The garment includes a plurality of sensors that are in operable communication with each other for detecting position data of each sensor of the plurality of sensors relative to each other and at least one chip that is in operable communication with at least one of the sensors of the plurality of sensors and configured to collect the detected position data and generate an image of a body portion of a user of the garment based on the detected position data and communicate the generated image to at least one display device for displaying the generated image.

### BACKGROUND

### Field of the Disclosure

The present disclosure relates to a garment, and more particularly, to a garment including a plurality of sensors and a chip that is configured to generate an image of a body portion of a user based on a distance between each sensor of the plurality of sensors.

### Description of the Related Art

Garments that include one or more types of sensors and that can be worn by a user to track a change of a body portion of the user are known. Such garments are in operable communication with one or more types of monitors or display devices that are configured to provide a two-dimensional image of the body portion of the user showing the change in the body portion.

While such garments are suitable for their intended purpose, there may exist a need for a garment including a plurality of sensors and a chip that is configured to generate an image of a body portion of a user based on a distance between each sensor of the plurality of sensors.

### SUMMARY

As can be appreciated, a garment including a plurality of sensors and a chip that is configured to generate an image of a body portion of a user based on a distance between each sensor of the plurality of sensors may prove useful in the physical fitness arena.

Embodiments of the present disclosure are described in detail with reference to the drawing figures wherein like reference numerals identify similar or identical elements. As used herein, the term “distal” refers to the portion that is being described which is further from a user, while the term “proximal” refers to the portion that is being described which is closer to a user.

In accordance with an aspect of the present disclosure, there is provided a garment. The garment includes a plurality of sensors that are in operable communication with each other for detecting position data of each sensor of the plurality of sensors relative to each other and at least one chip that is in operable communication with at least one of the sensors of the plurality of sensors and configured to collect the detected position data and generate an image of a body portion of a user of the garment based on the detected position data and communicate the generated image to at least one display device for displaying the generated image.

In accordance with another aspect of the present disclosure, there is provided a non-transitory computer readable storage medium have stored thereon instructions that when executed by a processor of at least one display device allow the at least one display device to perform a method for tracking a change of a body portion of a user of a garment including a plurality of sensors. The method includes detecting position data of each sensor of the plurality of sensors relative to each other, collecting the detected position data using at least one chip that is in operable communication with at least one of the sensors of the plurality of sensors, generating an image of the body portion of the user using the at least one chip based on the detected position data, and communicating the generated image to the at least one display device for displaying the generated image.

### BRIEF DESCRIPTION OF THE DRAWING

Various embodiments of the present disclosure are described hereinbelow with references to the drawings, wherein:

FIG. 1 is a front view of a garment including a plurality of sensors and a chip, in accordance with an embodiment of the present disclosure;

FIG. 2 is a rear view of the garment of FIG. 1; and

FIG. 3 is a diagram illustrating an electronic device in a network environment, according to various embodiments of the present disclosure.

### DETAILED DESCRIPTION

Detailed embodiments of the present disclosure are disclosed herein; however, the disclosed embodiments are merely examples of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

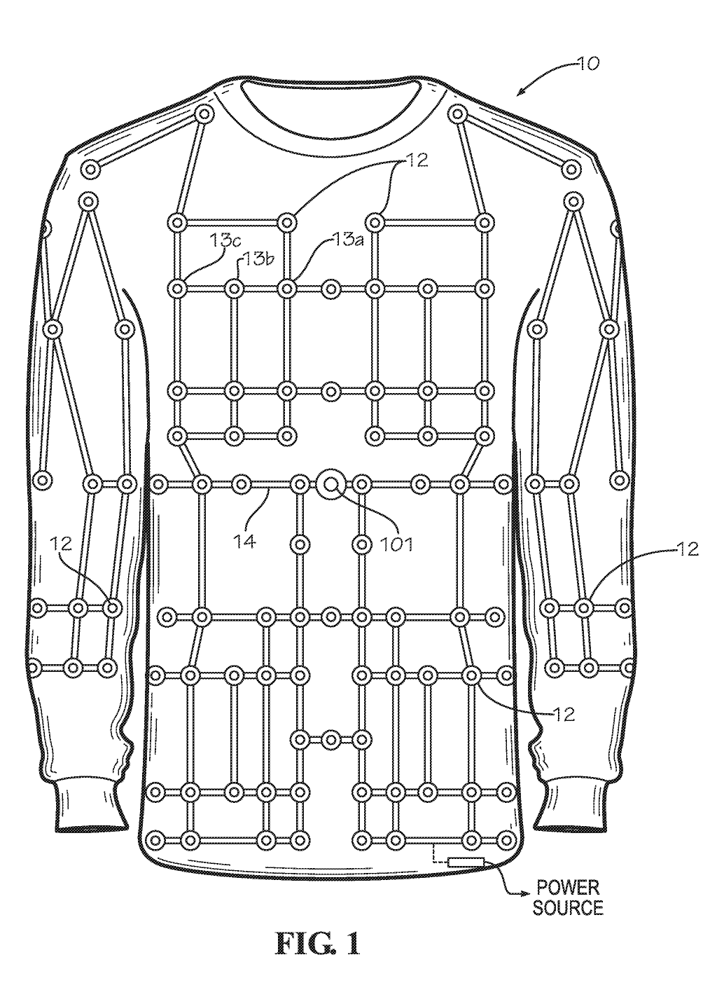

FIG. 1 is a front view of a garment 10 including a plurality of sensors 12 (sensors 12) and an electronic device, e.g., a system on chip (chip) 101, in accordance with an embodiment of the present disclosure.

The garment 10 can be made from any suitable material including, but not limited to, cotton, nylon, spandex, lycra, etc., or combination thereof, and can be configured to be worn on various body parts of a user. For illustrative purposes, the garment 10 is shown formed as a long-sleeved shirt, which is configured to be worn relatively tight on a user for positioning the plurality of sensors 12 as close as possible to a user's body, e.g., arms, chest, torso, etc.

Operatively coupled, attached or embedded to/in the garment 10 are the sensors 12 which are in operable communication with each other and are configured to detect position data relative to each other. The sensors 12 communicate with each other over one or more communication interfaces. For example, the sensors 12 can communicate over a wired and/or a wireless connection. In the former instance, the wired connection uses a coiled wire or an elastic wire 14 that allows the wire 14 to expand and contract as the sensors move relative to each other over time. Alternatively, a Bluetooth connection and/or a Wireless Fidelity (WiFi) connection can be used if the sensors communicate with each other wirelessly.

The sensors 12 can be any suitable type of sensor that is capable of detecting and/or collecting a position data. For example, a sensor 13a can be a position sensor that is configured to detect its position relative to a position of sensors 13b and 13c (see FIG. 1, for example), and vice versa. As used herein, a position sensor is defined as any sensor that is capable of being referenced either to or from some fixed point or position and that is capable of providing positional data/feedback. For example, the sensors 12 can be embodied in the form of potentiometers, inductive sensors (e.g., linear variable differential transformers), inductive proximity sensors, rotary encoders, magnets, or combination thereof. The position data is used for tracking a change in a dimension of a body portion on which the garment 10 is worn by a user, as described in greater detail below.

The plurality of sensors 12 can be disposed on an interior or an exterior of the garment 10, or the sensors 12 can be embedded within the fabric that forms the garment 10 (i.e., the sensors 12 can be positioned between two layers of fabric), and the sensors 12 can be affixed to the garment by any suitable affixation method, e.g., adhesive, stitching, etc. In either instance, the plurality of sensors 12 can be waterproof, thereby giving a user the ability to wash the garment 10.

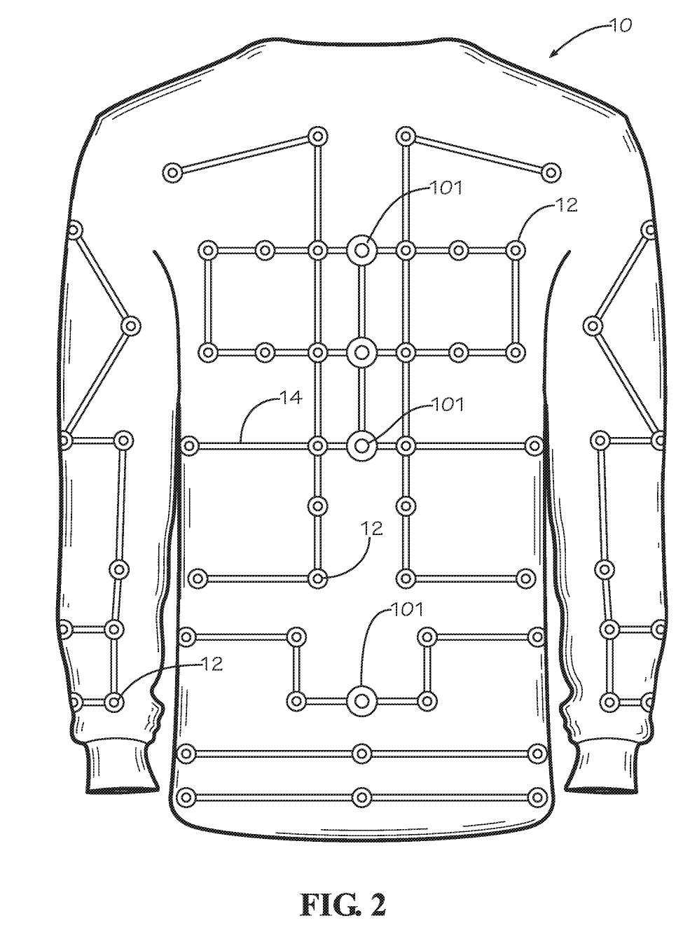

One or more SoCs 101 are operably coupled to the garment 10. For illustrative purposes, the garment 10 is shown including one SoC 101 that is disposed on a front of the garment 10 (FIG. 1) and three SoCs are shown disposed on a back of the garment 10 (FIG. 2); however, only a single SoC 101 can be provided on either the front or back of the garment 10.

The SoC 101 communicates with the sensors 12 (via a wired (e.g., the wire 14) or wireless configuration) for receiving and processing (compiling) the detected/collected position data from each sensor 12. The SoC 101 uses the processed position data to generate an image of a body portion on which the garment 10 is worn by a user. The SoC 101 communicates the generated image to one or more display devices for displaying the generated image.

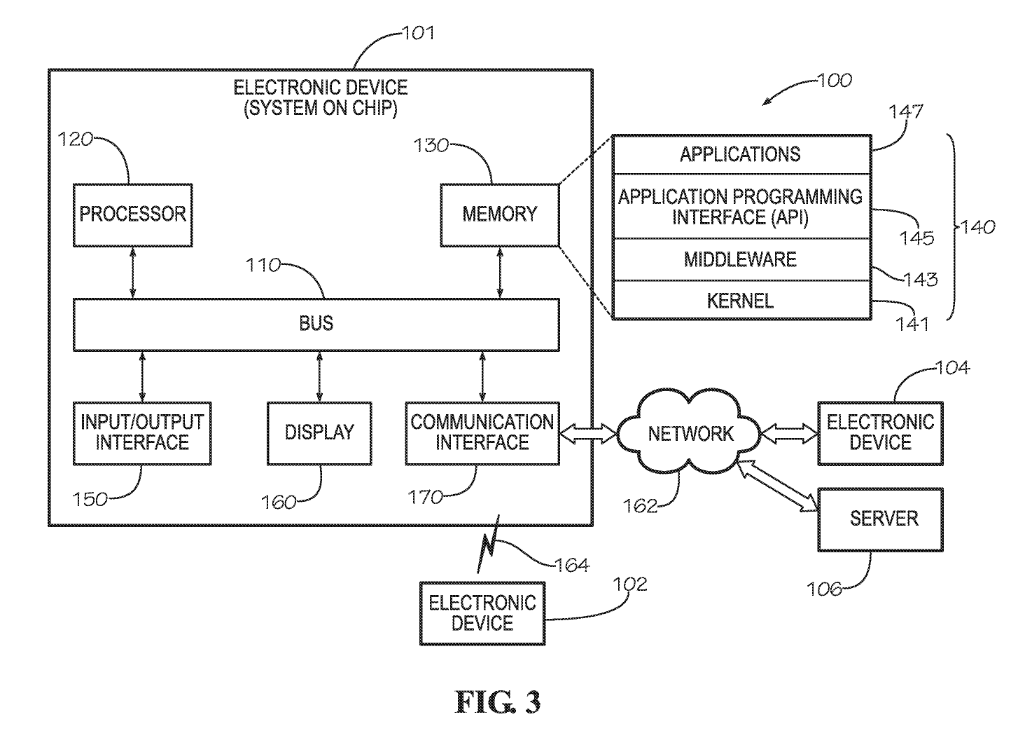

FIG. 3 shows the SoC 101 in a network environment 100, according to an embodiment of the present disclosure. The SoC 101 includes a bus 110, a processor 120, a memory 130, an input/output (I/O) interface 150, an optional display 160, and a communication interface 170. The SoC may omit at least one of the components, or may additionally include some other component(s).

The bus 110 may include a circuit that connects the components 110 to 170 to one another, and deliver communications (e.g., control commands and/or data) among the components 110 to 170.

The processor 120 may include one or more of central processing units (CPUs), application processors (APs) or communication processors (CPs). The processor 120 may perform data processing related to control and/or communications of at least one of the other components of the SoC 101.

The memory 130 may include volatile and/or nonvolatile memories. The memory 130 may store command or data involved in at least one of the other components of the SoC 101. The memory 130 may store software and/or a program 140. The program 140 may include, for example, kernel 141, middleware 143, application programming interface (API) 145, application program 147, and/or the like. At least a part of the kernel 141, middleware 143, or API 145 may be referred to as an operating system (OS).

The kernel 141 may control or manage system resources (e.g., the bus 110, the processor 120, the memory 130 or the like) to be used to carry out an operation or function implemented by the other programming modules, e.g., the middleware 143, the API 145, or the application program 147. Furthermore, the kernel 141 may provide an interface for the middleware 143, the API 145, or the application program 147 to access respective components of the electronic device 101 to control or manage system resources.

The middleware 143 may act as intermediary for the API 145 or the application program 147 to communicate data with the kernel 141 and may handle one or more requests for tasks received from the application program 147.

The API 145 is, for example, an interface for the application 147 to control a function provided from the kernel 141 or the middleware 143, and may include at least one interface or function (e.g., an instruction) for e.g., file control, window control, image processing, text control, etc.

The application program 147, under the control of the processor 120, includes one or more algorithms and/or sets of instructions that allow the processor 120 to compile the position data received from the sensors 12. More particularly, every time a user wears the garment 10, the control algorithm of application program 147 gathers position data obtained from the sensors 12 and stores the position data in the memory 130. The control algorithm generates an image of a specific body part on which the garment 10 is worn based on the stored position data. Over time, as a position of each of the sensors 12 changes relative to each other, a corresponding image of that specific body part will also change (i.e., based on the newly stored position data), and this change can be observed by a user on the display 160 or a display of one of the electronic devices 102, 104, or the server 106.

The I/O interface 150 may serve as an interface to deliver commands or data input from e.g., the user or an external device to other component(s) of the SoC 101. The I/O interface 150 may also output commands or data received from the other component(s) of the SoC 101 to the user or other electronic device(s).

In the instance where the SoC 101 includes the display 160, the display 160 may include e.g., a liquid crystal display (LCD), a light emitting diode (LED) display, an organic LED (OLED) display, micro-electromechanical system (MEMS) display, or an electronic paper display. The display 160 may display various contents, e.g., text, images, video, icons, symbols, etc., for the user. The display 160 may include a touch screen, which may detect touches, gestures, proximity or hovering inputs by way of an electronic pen or a body part of the user.

The communication interface 170 may establish communication between the SoC 101 and one or more external electronic devices 102, 104, and 106 via a network 162, through wired or wireless communication. The external devices 102, 104 can be a smart phone, smart watch (or other smart device), tablet, lap top, home personal computer (PC), television, etc. and the external electronic device 106 can be a server.

The wireless communication can be a cellular communication protocol, using at least one of e.g., long-term evolution (LTE), LTE-Advanced (LTE-A), code divisional multiplexing access (CDMA), wideband CDMA (WCDMA), universal mobile telecommunications system (UMTS), wireless broadband (WiBro), global system for mobile communications (GSM), etc.

The wireless communication may also include short-range communication 164. The short-range communication 164 may include at least one of e.g., WiFi, Bluetooth, near field communication (NFC), global navigation satellite system (GNSS), etc. The GNSS may include at least one of global positioning system (GPS), Glonass, Beidou, or Galileo.

The wired communication may include at least one of e.g., universal serial bus (USB), high definition multimedia interface (HDMI), recommended standard (RS) 232, plain old telephone service (POTS), and the like.

The network 162 may include a telecommunication network, e.g., at least one of computer networks (e.g., local area network (LAN) or wide area networks (WAN)), Internet, and telephone network.

All or a part of operations executed in the SoC 101 may also be executed in the electronic device devices 102, 104, or in the server 106. When the SoC 101 needs to perform a function or service automatically or on request, the SoC 101 may request the electronic device 102 or 104, or the server 106 to perform at least a part of the function or service, instead of or in addition to performing the function or the service by itself.

The SoC 101 can be removably coupled to the garment 10, or the SoC 101 can be fixedly attached to the garment 10. In either instance, as with the sensors 12, the SoC 101 can be waterproof. Moreover, the SoC 101 can be positioned on the garment 10 in a manner similar to the sensors 10, e.g., an interior or exterior of the garment 10, or embedded within the garment 10 between two layers of fabric.

The garment 10 can be configured to connect to a power source (not shown) for charging the SoC 101 and/or the sensors 12. Conversely, the SoC and/or the sensors 12 can be battery powered.

One or more buttons or switches (not shown) may be provided on the garment 10 to activate the application 147 on the SoC 101. Alternatively, the application 147 on the SoC 101 may be configured to automatically detect when the garment 10 is positioned on user. For example, one or more a thermocouples (not shown) may be provided on the garment 10 and may be configured to detect a when a temperature (e.g., body temperature) reaches a predetermined threshold for a predetermined amount of time.

In use, a user can put on the garment 10. When the garment 10 is positioned on a user, and if the thermocouple detects that a temperature has reached a predetermined threshold for the predetermined amount of time, the processor 120 of the SoC 101 activates the application program 170. Once activated, the application program 170 sends a command signal to the processor 120 to enable each of the sensors 12 collect position data. Or, the sensors 12 can be configured to collect data automatically, without receiving a command signal from the processor 120.

The collected position data is transmitted to the processor 120 which transmits the collected position data to the memory 130 so that the control algorithm of the application program 147 can generate an image of the body part on which the garment 10 is worn, in the illustrated embodiment, a user's upper body including the torso, arms, chest, and shoulders.

The generated image can communicated via the communication interface 170, through either wired or wireless communication, to one of the electronic devices 102, 104 (or the server 106) and outputted to a display of the thereof so that a user can view the generated image (a two-dimensional or three-dimensional image), which can be stored in a memory of the electronic devices 102, 104, which can also have the application program 170 stored thereon.

Over time, as the position data collected by the sensors 12 changes, the control algorithm of the application program 147 detects these changes and generates a new image of the body part on which the garment 10 is worn, thereby allowing a user to view any changes to that specific body part. In one particular embodiment, a new image can be overlaid on a previously stored image so that a user can clearly visualize the specific changes of the body part. Moreover, individual position data associated with each of the sensors 12 can be displayed for a user to view.

A third, fourth, fifth, and so on, with extremely small time intervals in between one another can also be obtained, thereby allowing the garment 10 to track motions of a user; this could be used to allow a user to examine paths of movement of the user. For example, while a user is performing a bicep curl, the garment 10 can be used to track a motion of the user's body, e.g., their bicep, which could be used to improve their path of movement of the bicep curl and thereby maximizing the workout.

From the foregoing and with reference to the various figure drawings, those skilled in the art will appreciate that certain modifications can also be made to the present disclosure without departing from the scope of the same. For example, the SoC 101 of the garment 10 can be configured to receive a user input via one or the electronic devices 102, 104, or server 106. For example, if the application program 170 is downloaded on the electronic device 102, the application program 170 can be configured to provide a user interface (e.g., a user menu) for receiving a user input for interacting or customizing the application program 170, according to a user's specific needs.

In this instance, for example, a user can enter information relating to a specific body part of the user, or can enter control information, such as information for controlling a display appearance of a generated image (e.g., size, color, contrast, brightness) or of a generated graph, which can also be generated by the application program 170 and which can provide a graphical representation of a change in a user's specific body part.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A garment comprising:
a plurality of sensors that are in operable communication with each other for detecting position data of each sensor of the plurality of sensors relative to each other; and
at least one chip that is in operable communication with at least one of the sensors of the plurality of sensors and configured to collect the detected position data and generate an image of a body portion of a user of the garment based on the detected position data and communicate the generated image to at least one display device for displaying the generated image.

2. The garment according to claim 1, wherein each sensor of the plurality of sensors communicates with each other over one of a wired and wireless connection.

3. The garment according to claim 2, wherein the wireless connection is one of a Bluetooth connection and Wireless Fidelity (WiFi) connection.

4. The garment according to claim 2, wherein the wired connection uses a coiled wire that allows the wire to expand and contract as each sensor of the plurality of sensors moves relative to each other over time.

5. The garment according to claim 1, wherein the at least one display device is selected from the group consisting of a smart device, laptop, personal computer, and television.

6. The garment according to claim 1, wherein the at least one chip communicates with the display device over one of a wired and wireless connection.

7. The garment according to claim 1, wherein the at least one chip is removably attached to the garment and configured to attach to the at least one display device.

8. The garment according to claim 1, wherein each sensor of the plurality of sensors is adjustable so that a position of each sensor of the plurality of sensors can be changed on the garment.

9. The garment according to claim 1, wherein the generated image at the at least one display device is a three-dimensional (3-D) image.

10. The garment according to claim 1, wherein the garment is configured to be worn relatively tight on the body portion of the user so that each sensor of the plurality of sensors is in substantial contact with the body portion of the user.

11. The garment according to claim 1, wherein the garment is one of an exercise shirt and exercise pants or shorts.

12. The garment according to claim 1, wherein the at least one chip has stored thereon a plurality of computer readable instructions that when loaded on the at least one display device and executed by a processor of the at least one display device allows a user to compare an image of a body portion of the user generated at a first time based on a first set of position data with an image of the body portion of the user generated at a second time based on a second set of position data for tracking changes in the body portion of the user from the first time to the second time.

13. A non-transitory computer readable storage medium have stored thereon instructions that when executed by a processor of at least one display device allow the at least one display device to perform a method for tracking a change of a body portion of a user of a garment including a plurality of sensors, the method comprising:
detecting position data of each sensor of the plurality of sensors relative to each other;
collecting the detected position data using at least one chip that is in operable communication with at least one of the sensors of the plurality of sensors;
generating an image of the body portion of the user using the at least one chip based on the detected position data; and
communicating the generated image to the at least one display device for displaying the generated image.

14. The non-transitory computer readable storage medium according to claim 13, wherein each sensor of the plurality of sensors communicates with each other over one of a wired and wireless connection.

15. The non-transitory computer readable storage medium according to claim 14, wherein the wireless connection is one of a Bluetooth connection and Wireless Fidelity (WiFi) connection.

16. The non-transitory computer readable storage medium according to claim 14, wherein the wired connection uses a coiled wire that allows the wire to expand and contract as each sensor of the plurality of sensors moves relative to each other over time.

17. The non-transitory computer readable storage medium according to claim 13, wherein the at least one display device is selected from the group consisting of a smart device, laptop, personal computer, and television.

18. The non-transitory computer readable storage medium according to claim 13, wherein the at least one chip communicates with the display device over one of a wired and wireless connection, and wherein the at least one chip is removably attached to the garment and configured to attach to the at least one display device.

19. The non-transitory computer readable storage medium according to claim 13, wherein each sensor of the plurality of sensors is adjustable so that a position of each sensor of the plurality of sensors can be changed on the garment.

20. The non-transitory computer readable storage medium according to claim 13, wherein the generated image at the at least one display device is a three-dimensional (3-D) image.
